(19) United States
(12) Patent Application Publication
(10) Pub. No.: US 2007/0143465 A1
(43) Pub. Date: Jun. 21, 2007

(54) Connection Tapping

(76) Inventors: Roberta Lynn Gonzalez, Santa Monica, CA (US); Michael Van Harding, Los Angeles, CA (US); Jack Lawson Bishop III, Thousand Oak, CA (US)

Correspondence Address: SoCAL IP LAW GROUP LLP, 310 N. WESTLAKE BLVD. STE 120, WESTLAKE VILLAGE, CA, 91362, US

(21) Appl. No.: 11/567,696

(22) Filed: Dec. 6, 2006

Related U.S. Application Data
(60) Provisional application No. 60/742,958, filed on Dec. 6, 2005.

(51) Int. Cl. G06F 15/173

(52) U.S. Cl. 709/223

(57) ABSTRACT

There are disclosed systems and methods for managing network devices and/or physical layer devices involving a server computer, a client computer coupled with the server computer, and a connector device coupled with the server computer, and a plurality of network devices and/or physical layer devices coupled with the connector device. A management application executing on the server may provide a graphical user interface allowing for the selection and arrangement of the network devices and/or physical layer devices into a use case. The management application may provide the graphical user interface in conjunction with a client application that executes on the client computer. Taps and monitors may be added to the arrangement and the use case.

### RELATED APPLICATION INFORMATION

This patent application claims priority to provisional patent application no. 60/742,958 filed Dec. 6, 2005 entitled Connection Tapping, which is incorporated herein by reference in its entirety.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This patent application relates to network devices and monitoring, configuring and managing network devices in a lab, in a network and in network labs.

2. Description of the Related Art

Laboratories, test facilities, and network equipment facilities include many interconnected devices test that may be tested and accessed by various users such as testers. Laboratory environments are frequently neither logical nor orderly and may be connect devices in a quite confusing tangle of cables and connectors. Terms like “rats'nest” or “spaghetti” are commonly used by laboratory users to describe messy laboratory arrangements and environments.

The manual interconnection and operation of devices is often conducted by selecting and plugging in patch cables directly to devices or via cable patching systems. Sometimes it is not apparent what connections between devices are required or allowed, and incorrect cable selection and device connections often result. Further, because laboratories are often shared, it is not unusual for testers to encounter schedule conflicts over access to devices. Most laboratories do not have any kind of reservation system which results in a trial-and-error method of gathering devices for a particular test. This can result in equipment-hoarding behavior and low device utilization rates.

Documentation of test results is also a significant source of frustration and inefficiency. Testers often manually record the conditions and results in notebooks or on scraps of computer paper.

Test scripts which may be used on one device are not typically usable on other devices. Further, when a test needs to be re-created, a significant amount of time may be spent attempting to re-create the test environment, connections and conditions.

### DESCRIPTION OF THE DRAWINGS

FIG. 1 is a block diagram showing an example environment in which the management application software described herein may be used.

FIG. 2 is a block diagram showing a generalized environment in which the management application software may be used.

FIG. 3 is a screen shot of the main window of a management application software described herein.

FIG. 4 is a portion of a screen shot of the graphical user interface for adding a tap as provided by the management application software described herein.

FIG. 5 is a portion of a screen shot showing a tap and network devices as provided by the management application software described herein.

FIG. 6 is a screen shot showing a tap properties windows provided by the management application software described herein.

FIG. 7 is a portion of a screen shot showing a monitor, a tap and connected network devices along with a monitor properties menu provided by the management application software described herein.

FIG. 8 is a portion of a screen shot showing a monitor and a monitor properties menu provided by the management application software described herein.

FIG. 9 is a portion of a screen shot showing a monitor and a monitor properties menu provided by the management application software described herein.

### DETAILED DESCRIPTION

Throughout this description, the embodiments and examples shown should be considered as exemplars, rather than limitations on the systems and methods disclosed or claimed.

Environment

The systems and methods described herein include a management application that provides automated re-configurations, asset management, and remote access to network devices in a lab, network lab or other network.

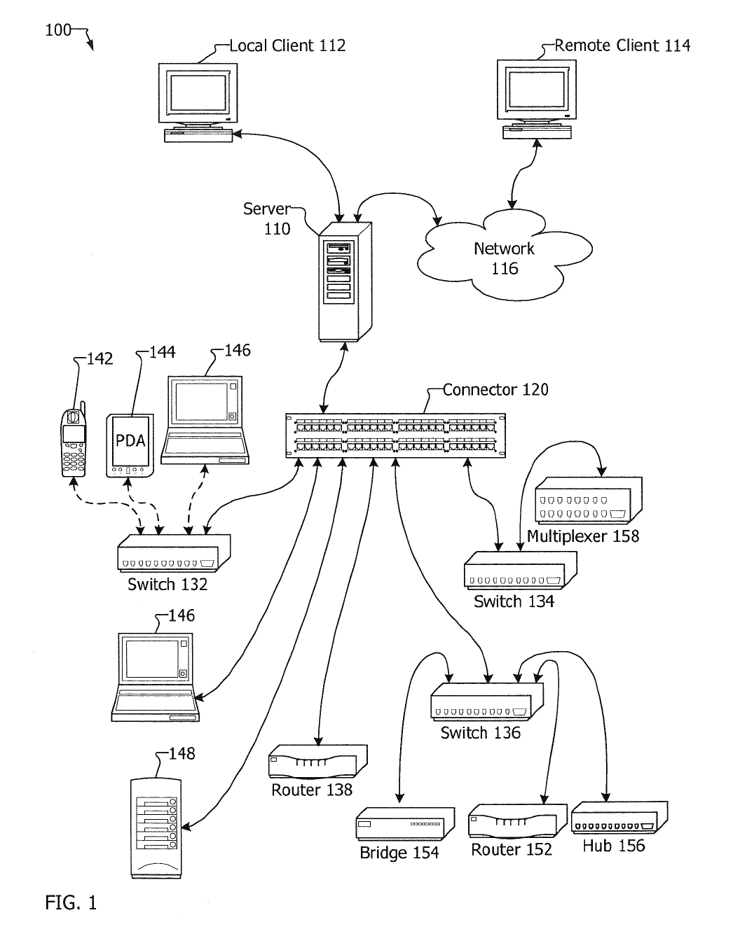

FIG. 1 is a block diagram showing an example environment 100 in which the management application may be used. In the example environment 100, the management application is software that is stored on and executed by server 110. A user may access the management application from local and/or remote client devices such as local client 112 and remote client 114. The local client 112 may be coupled directly with the server 110 or through a local network (not shown). The remote client 114 may be coupled directly with the server 110 or through a network 116. A user from another building, town, city, state or half way across the world may access the features of the management application on server 110 through remote client 114. The local client 112 and remote client 114 are typically personal computers, computer workstations, and laptop computers and may be other computing devices, as defined below. Although only one each of local client 112 and remote client 114 are shown, the methods and systems described herein may be used with multiple local clients 112 and remote clients 114. The server 110 is coupled to connector device 120.

The management application provides for application management of physical layer switches and/or other switches 132, 134 and 136. The term “physical layer” refers to layer 1 of the Open System Interconnection (OI) model of network communication protocols. The management application permits sharing of network devices among multiple users, resulting in increased usage. The management application may contribute to or cause a reduction in wasted time and inefficiencies associated with manual tracking, patching and equipment reconfiguration involving the network devices. In a lab testing configuration, the management application may result in reduced time-to-market for a network device under test.

The term “computing device” as used herein refers to any device with a processor, memory and a storage device that may execute instructions including, but not limited to, personal computers, server computers, computing tablets, personal digital assistants (PDAs), cellular telephones, portable computers, and laptop computers. These computing devices may run an operating system, including, for example, variations of the Linux, Unix, Solaris, MS-DOS, Microsoft Windows, Palm OS, Symbian, and Apple Mac OS X operating systems.

Referring again to FIG. 1, the configuration of network devices shown does not represent a typical selection and arrangement of network devices used with the management application. Rather, FIG. 1 shows some of the network devices that may be used with the management application that executes on server 110. Various network devices may be coupled with the connector device 120. Connector device 120 may be a patch bay, a physical layer switch, an optical switch, and others. In one configuration, connector device 120 is a Media Cross Connect device from MRV Communications of Chatsworth, California. The connector device 120 may be a switch available from Apcon, Calient, Continuum Photonics, Curtiss-Wright, Cytec, Eastern Research, Glimmerglass Networks, Lynx, Polatis, Racal Instruments, Universal Switching, and others. Multiple switches from multiple manufacturers may be transparently managed simultaneously from one single server application running on the server 110, referred to herein as the management application, while a user accesses a client application on a client device 112 and 114 to manage and control the functioning of network devices coupled with the connector device 120 via the management application.

The management application may provide a graphical user interface to its functionality directly and/or through the client application. In one embodiment the client application is an Internet browser on a client computer that accesses the management application on the server computer. Example Internet browsers include Firefox, Microsoft Internet Explorer, Opera, Safari, and the like. In another embodiment, the client application is a software program provided by the same entity that provides the management application.

As shown in FIG. 1, the management application running on server 110 may allow for the control and management of various network devices that are coupled with the connector 120. As shown in FIG. 1, for example only, the network devices that may be coupled with connector device 120 may be one or more of each of switches 132 and 134, and 136. Other networking devices may be coupled with connector device 120. Other networking devices may be coupled with switches 132, 134 and 136. For example, one or more multiplexers 158 may be coupled with switch 134. Further, one or more of each of bridge 154, router 152 and hub 156 may be coupled with switch 136. In addition, various other network devices may be coupled with connector device 120, such as, for example, router 138, laptop computer 146 and network attached storage 148. A laptop computer 146, a PDA 144, a cellular telephone 142, and other computing devices as well as other network devices may be coupled with a switch 132 which is coupled with the connector device 132. The computing devices (the laptop computer 146, the PDA 144, the cellular telephone 142 and others) may be coupled with the switch 132 via wires and/or wirelessly. devices. The management application may permit users to track device usage, behavior, and functioning. The management application may allow a user to apply stored configurations including recalling, scheduling, and sharing of stored configurations. The management application may provide automated re-configuration of devices. The management application may manage physical layer switches (for example, switches 132, 134 and 136 in FIG. 1) to which devices are connected.

Various and multiple network devices may be coupled to the connector device 120. As used herein the term “network device” means any device capable of communicating on a network. Network devices include routers, switches, hubs, firewalls, multiplexers, gateways, bridges, load balancers, printers, multi-function peripherals, network attached storage (NAS) devices, drive arrays, and computing devices. In addition, home appliances such as refrigerators, heating and air conditioning controllers and systems and other devices capable of network communication are within the definition of network devices used herein.

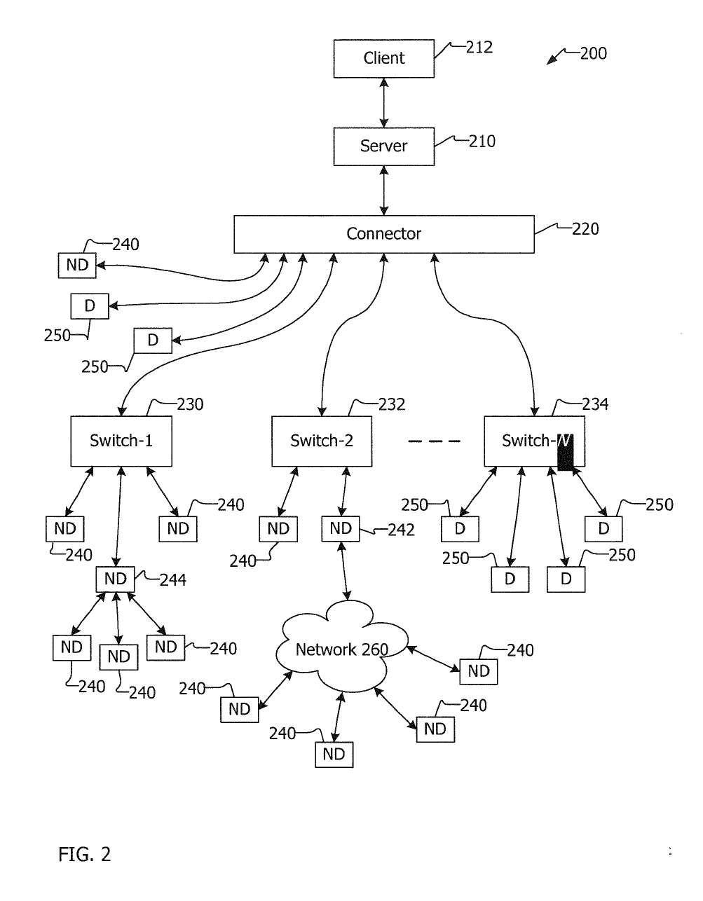

FIG. 2 is a block diagram showing a generalized environment 200 in which the management application software may be used. One or more clients 212, a computer or other computing device, may be coupled directly or via a network with, from a local or remote location, with a server 210 running the management application. The server may be coupled with a connector device 220. Multiple network devices 240 and physical layer devices 250 may be coupled directly with connector device 220. Physical layer devices 250 may be layer one physical layer devices that are not capable of network connections, such as, for example, signal generators. The network devices 240 may all be the same kind, type or model of network device or may be multiple different kinds, types or models of network devices. Multiple switches Switch-1 230, Switch-2 232 and Switch-3 234 may be coupled with connector device 220. In one embodiment, no network devices or other devices are coupled with the switches 230, 232 and 234. More typically, other network devices 240 and/or physical layer devices 250 are coupled with switches 230, 232 and 234, as shown. The network devices 240 may be coupled via wires or wirelessly with the switches 230, 232 and 234. Some of the network devices 242 coupled with switches such as Switch-2 232 may connect to a network 260 where other network devices 240 are coupled. For example, network device 242 may be a firewall, gateway, router, or other network device. Some of the network devices 244 coupled with switches such as Switch-l 230 may have network devices 240 coupled therewith. For example, network device 244 may be a firewall, gateway, router, or other network device.

The processes, functionality and features of the management application may be embodied in whole or in part in software which operates on a computer such as a server computer shown 110 and 210 in FIGS. 1 and 2. The management application may be an application program which may include source code and compiled source code in the form of libraries as well as plug-ins, and may also include firmware, one or more applets (e.g., a Java applet), a browser plug-in, a COM object, a dynamic linked library (DLL), a script, one or more subroutines, an operating system component or service. The management application and/or other software as well as the server and/or other hardware and their functions may be distributed such that some components are performed by one computer and others by other computers or computing devices. That is, although only one of each of server 11O and server 210 is shown in FIGS. 1 and 2, one or more servers 110 and 210 or combination of servers, devices and/or computing devices may be used.

The management application may be stored permanently or temporarily on a storage media which may be included in a storage device which may be included with or otherwise coupled or attached to the servers 110 and 210 or other computing device. These storage media include, for example, magnetic media such as hard disks, floppy disks and tape; optical media such as compact disks (CD-ROM and CD-RW) and digital versatile disks (DVD and DVD±RW); flash memory cards and devices (for example, thumb drives, SD memory cards, and others); and any other storage media. As used herein, a storage device is a device that allows for reading and/or writing to a storage medium. Storage devices include, hard disk drives, DVD drives, flash memory readers/writers, and others.

As used herein the term data unit shall mean a frame, cell, datagram, packet or other unit of information.

### The Management Application

The management application provides automated configuration, asset management, and remote access for labs or other groups of network devices. The management application communicates with and controls various third-party physical layer switches. The term “physical layer” refers to layer 1 of the Open Systems Interconnection (OSI) model of the International Standards Organization (ISO). Using the management application allows for the elimination of wasted time and other inefficiencies associated with manual tracking, patching and equipment reconfiguration of multiple network devices in a lab or other environment.

The management application may include an internal scheduler to allow for the sharing of lab resources among multiple users. The management application allows test cases to be run with managed equipment and network devices. The management application may be integrated with third-party test management systems. The management application permits users to track lab resource usage, design and apply configurations from a computer desktop, and recall, schedule and share those configurations.

The management application may serve as a front-end system for multi-user, multi-vendor networking and lab environments. The functionality of the management application may be provided to a user directly and/or through a client application on a client computer. The management application provides automated re-configurations, secure remote presence, and asset management. The management application consists of a client/server application with a Graphical User Interface and may provide application programming interfaces (APIs) (which may be accessed using Tcl, Perl, and other scripting and compiled languages) to manage physical layer switches and other switches to which physical layer devices and network devices are connected. The management application allows for “hands-off” reconfigurations of lab network devices. The management application allows for improvements in efficiency, security, equipment availability and sharing, and/or asset tracking. The management application may particularly benefit networks or labs requiring sharing of network devices among multiple users, frequent re-configurations, test automation, asset tracking, and/or secure remote access to network device in a remote lab.

The management application may automate laboratories so that use of network devices is optimized among lab users. The management application may control third party physical layer switches to which network devices are connected. The management application may serve in some ways as a software-controlled patch panel that allows resources to be securely accessed, switched, reserved and controlled remotely. As shown above in FIGS. 1 and 2, network devices, also referred to as devices under test, are physically connected to one or more switches. The management application provides for configuration of the network devices, and configuration with a drag-and-drop graphical user interface (GUI) and/or automated scripts. The management application enables the sharing of network devices such as expensive test equipment and other lab resources, and increases test repeatability and consistency.

The management application may provide a GUI, directly to a user and/or to a user at a client computer, that allows a user to perform one or more of the following actions: search for available devices that have specific attributes; define generic configurations with device types that may be replaced with available network devices at a time of reservation; and assign domain rights to users to limit access privileges to certain network devices.

The management application may allow a user to track the utilization of network devices in a lab, whether connected through a switch or not. The management application may include a reservation system that allows multiple users to reserve network devices and their resources, down to the port level, and may automatically connect those ports.

The management application manages cross-connects or switches that interconnect network devices in a lab or other environment. The management application can manage virtual switching matrices of switches from disparate manufacturers while keeping the switching infrastructure transparent to the user of the management application.

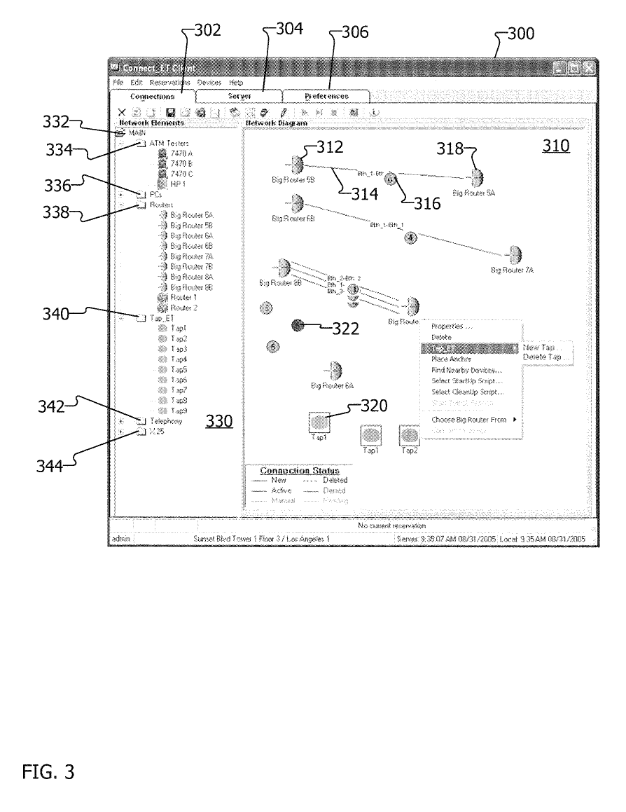

FIG. 3 shows a main window 300 of the management application and constituent panes and user interface items. The main window 300 may have three tabs, a connections tab 302, a server tab 304 and a preferences tab 306. The connections tab 302 allows for the presentation of a network diagram pane 310 and a network devices pane 330. The management application may provide a GUI that allows a user to drag and drop icons representing network devices to create usage cases which can be stored, re-used and shared for instant re-configuration and repeatability of testing. A usage case is an arrangement of network devices, taps (described below), and/or monitors (described below), as well as communication lines, other constructs and related configuration data. A test may be run on, over and/or through a use case. The management application allows a user to select a network device from the network devices pane 330 and drag the device to the network diagram pane 310 where a use case may be created. The management application may also make network devices and network elements available via a toolbar, tool pad and/or a pull down menu. The user may arrange network devices 312, 316 and 318 and connect them by dragging/drawing lines 314 between the network devices 312, 316 and 318. This may be achieved using a pencil tool or similar graphical user interface construct. The line may be an available communications medium, such as, for example, Ethernet, X.25, telephony, fiber optic and others, or may be within a switch. Element 316 represents a tap (described below) as added to an existing connection.

The network device pane 330 may include various network devices arranged by category or type, as well as a listing of existing or available taps and communications media. In the example shown in FIG. 3, the network device pane 330 provided by the management application includes a main folder 332 of ATM testers 334, a folder of PCs 336, routers 338, taps 340, telephony devices, and X.25 devices. Other folders for other kinds, types, and classes of device may also be included in the network device pane 330.

A user may add taps 322 and monitors 320 to the use case. The management application may receive user selection and designation of taps and monitors. The management application may include a tap feature which enables tapping into existing connections between network devices in active use cases. Adding a tap 320 as tap 316 creates a duplicate of a data connection that can be sent to one or more monitors 322. If the duplicate is sent to multiple monitors, the result is effectively multicasting the original signal. In general, connections between network devices or ports of network devices are made in pairs, and any port can generate multicast communications traffic. The management application allows a user to listen on one side of an ongoing connection. Each end-point of a connection may send data units to a listening port. As such, two ports are used to listen to a full connection between two network devices. Analyzers may be inserted in a “thru” mode, meaning the original connection may be broken, and an analyzer with two fill-duplex ports may be inserted between them. Alternatively, a full-duplex connection may be redirected from one endpoint to an analyzer instead of to its original target device.

The management application supports tapping into existing connections in active use cases using capabilities provided by some switch manufacturers. This is referred to herein as connection tapping. In general, connections are made in pairs: one network device transmits to another and receives from another. As such, a bi-directional connection includes two “listening” and two “transmitting” ports.

The management application includes to two GUI components that are used with connection tapping: taps and monitors. A tap is a GUI element that links to an existing connection and provides a virtual data source from the transmit port on a device. A monitor is a GUI element that is used to connect a tap to another device (for example, an analyzer) that will receive the transmitted data from a tapped connection. Usage cases may contain zero or more taps and zero or more monitors.

As used herein, a “tap” is a logical connection to a connection between two device ports. In various embodiments, taps may have a reference identifier (ID) which is <blank>or a user specified label, or may have the values 0-9, or other numerals or alphanumeric sequence. Each tap may be associated with zero or more “monitors” in a usage case. A “<blank>” tap is always considered a unique reference ID. Multiple “<blank>”taps may exist for a usage case. In one embodiment, each tap in a usage case has a unique reference ID. That is, more than one tap cannot have the same reference ID in a usage case. In this embodiment, a tap can have the same reference ID across different usage cases. For example, tap 0 for usage case 1 may be different from tap 0 for usage case 3. In one embodiment, the management application does not support taps for manual connections. As such, in this embodiment, the GUI does permit the creation of taps for manual connections.

As used herein, a “monitor” is a logical endpoint for a tap. Each monitor is a “virtual device” that other devices in a usage case connect to. Monitors can have a value of <blank>or can be associated with tapped connections by using the tap's associated reference number (0-9). Monitors are associated with a “tap” with the same reference ID. For example, monitor 3 is logically associated with tap 3 in a particular usage case. More than one monitor may have the same reference ID in a usage case. When more than one monitor has the same reference number in a usage case a multicast results. There is no limit to the number of monitors that share a reference ID, although some switches may impose an upper limit. When that upper limit is met or exceeded, the limit may be displayed during a reservation request and/or a failure notification may be provided via a display, audible notification or other alert as a failed connection. A monitor may be connected to another monitor. In another embodiment, the management application does not support connecting one monitor device to another. As such, in this embodiment, the GUI of the management application does permit the connection.

In one embodiment, the management application does not allow for tapping the connection between a monitor and a network device. As such, the GUI of the management application does permit the tap creation.

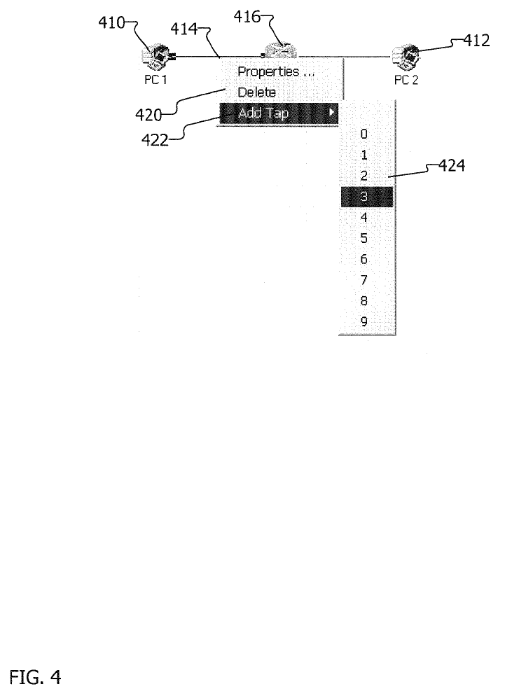

FIG. 4 is a portion of a screen shot showing the GUI for adding a tap. The management application provides for the adding of a tap between two network devices 410 and 416 by right-clicking on an existing connection 414. The management application provides a pull-down menu 420 from which the user may select the “add tap action” 422. The management application then provides a tap reference menu 424 from which the user may select the proper tap reference.

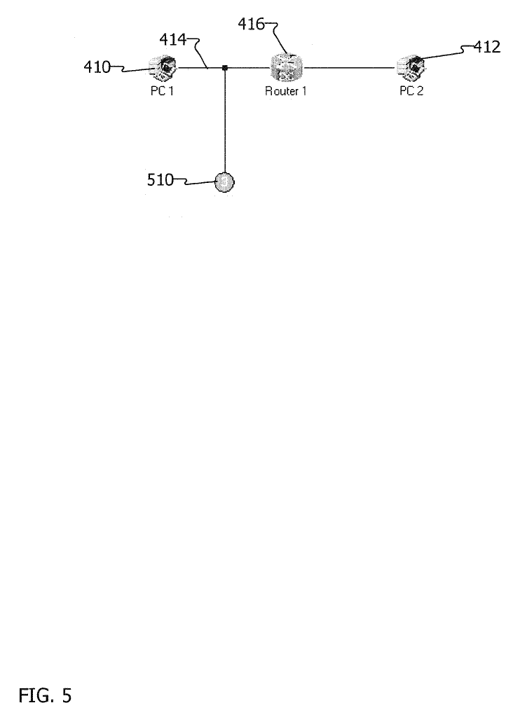

FIG. 5 is a portion of a screen shot showing the newly added tap 510 resulting from the actions described regarding FIG. 4. The management application allows the user to move the tap 510 on the network diagram by left-clicking and dragging the tap icon 510.

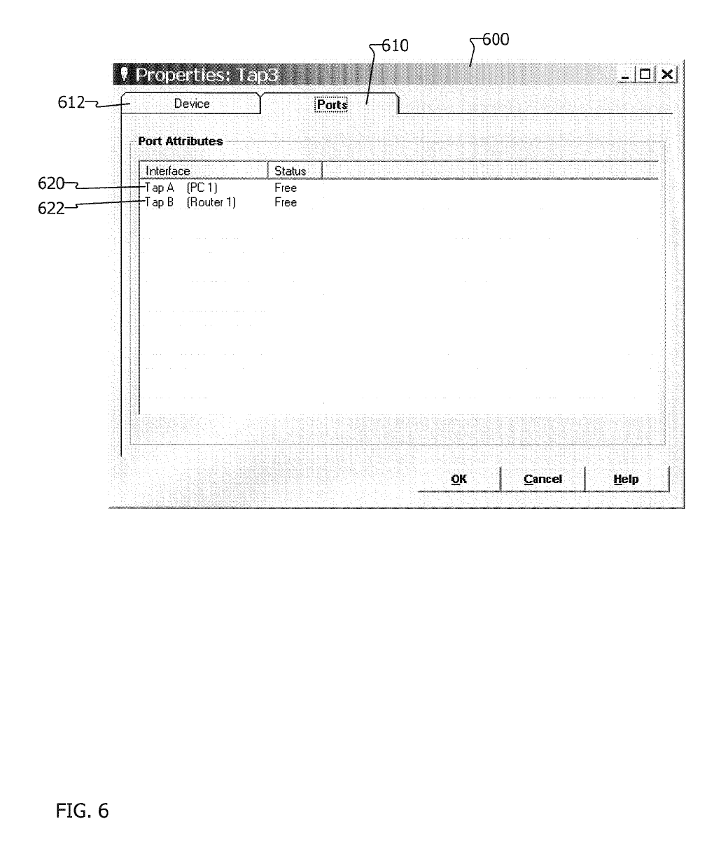

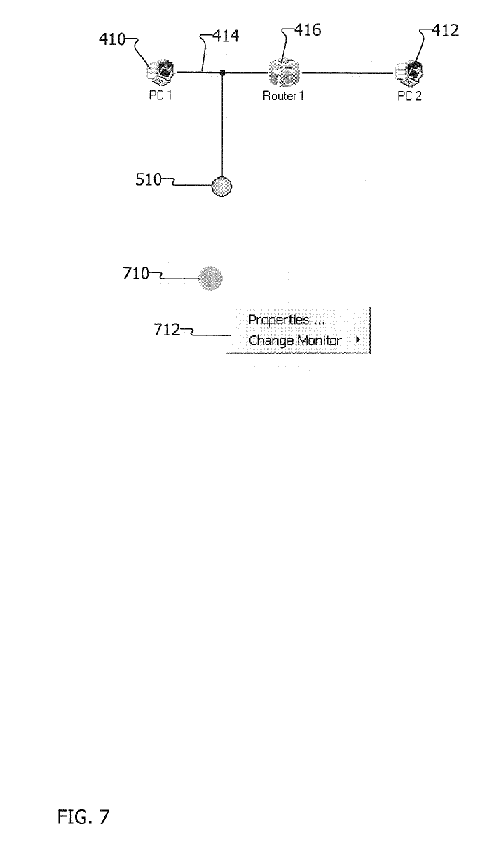

FIG. 6 shows a screen shot of tap properties window 600 showing some of the properties of a tap. The management application makes tap properties available when a user right clicks on the icon representing the tap. For example, the management application provides tap properties window 600 as a result of the user right-clicking on tap 510 shown in FIG. 5. The window 600 that includes the port connections 610 between devices on both sides of the tap. In this example, the tap contains logical connections “A” and “B” for transmission traffic designated as “Tap A” 620 and “Tap B” 622. The management application also provides device information available via tab 612 in window 600. P FIG. 7 is a portion of a screen shot that shows how a user of the management application may add a monitor to a use case using a monitor properties menu 712. The management application allows a user to add a monitor by clicking on and dragging a monitor element from the network elements pane to the network diagram of the use case. The management application allows the user to move the newly added monitor 710 to a desired location on the network diagram by left clicking and dragging. A monitor may be connected to a network device such as an analyzer. The pencil tool may be used to draw a connection between the monitor and any network device. The management application allows the user to access monitor properties by right clicking on a monitor icon. The management application provide a monitor properties selection menu 712 when a user right clicks on the monitor icon.

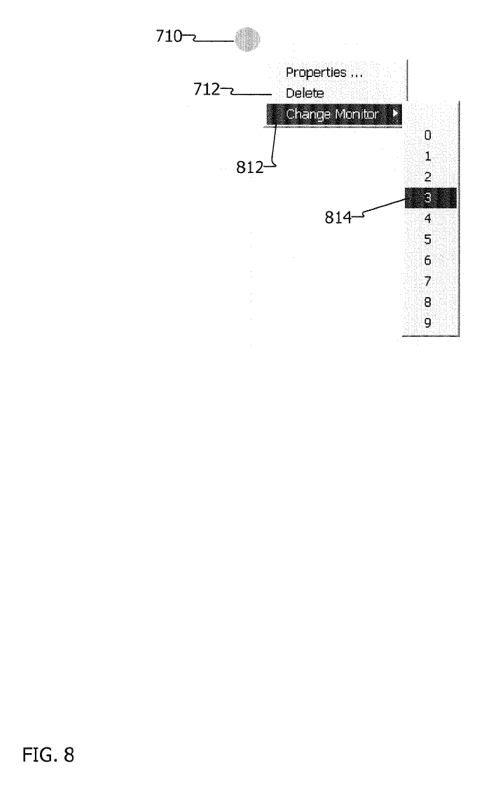

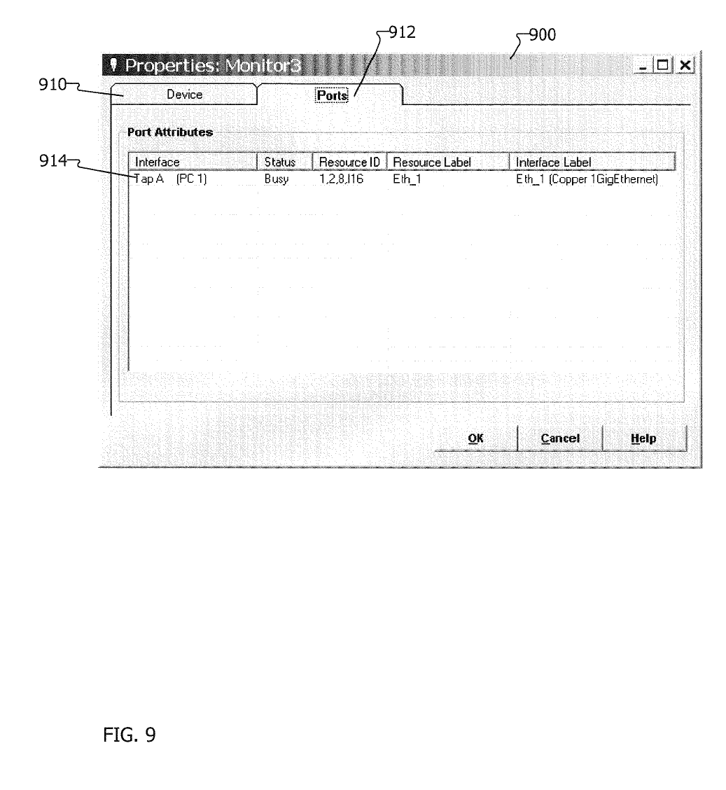

FIG. 8 shows a monitor 710 and a monitor properties selection menu 712. The monitor properties menu 712 allows a user to change the monitor's association with one or more taps. When a user selects “change monitor” 812 from the monitor properties menu 712, the management application displays a menu of available taps 814 to which the monitor may be associated. When a user selects one of the taps from the available taps menu 814, the management application may display a monitor properties window 900 as shown in FIG. 9.

FIG. 9 shows a monitor properties window 900. The monitor properties window may contain tabs for devices 910 and ports 912. Each monitor may contain logical connections “A” and “B” for transmission traffic designated as “Tap A” and “Tap B”. Tap A 914 is shown in FIG. 9.

The management application may also provide an additional element referred to as a connection point. As used herein, a connection point allows a point-to-point connection to be interrupted and continued at another location. Connection points can be used within a usage case in order to allow connections to be drawn to devices where a direct connection would be inconvenient or graphically confusing. Connection points are similar to monitors as described previously, but are symmetrical. That is, a monitor provides for a single direction communication, a connection point provides for two-way communication.

Connection points allow connections to entities external to the usage case. Connection points allow for connection between one usage case and a connection point in another usage case. The connection may be enabled by indicating the usage case desired, as well providing an identifier, such as a text name or connection number. Alternatively, a system-wide unique identifier may be used to designate connections. Connections may be accessed from the network elements window 330 shown in FIG. 3 or made available via a toolbar, tool pad and/or a pull down menu. In one embodiment, taps and monitors may be used in an analogous manner to connect to other use cases.

The management application may also provide an additional element referred to as a modifier. The management application may allow a user to modify the characteristics of a connection under test by using modifiers. A modifier may allow a user to perform a modification of a communications signal between two of the network devices. A modifier may be used to add random noise to a signal to test performance under noisy conditions. The management application may provide a network element for the modifier. The placement of a modifier on a connection line may be used to indicate that the signal being connected should be modified between the devices on either side of the modifier. Modifiers do not need specify any particular device for modifying the signal on a connection line. The management application may construct an appropriate path to perform the desired signal modification. Modifier may be applied in series. Modifiers in series may be represented as (a) stacked on top of each other, similar to a stack of chips or deck of cards, (b) as adjacent to each other or simply on the same line in any desired locations, (c) within a single modifier, with the series of modifications represented by a text label, and/or (d) within a menu representing properties of the connection.

Modifiers may be accessed from the network elements window 330 shown in FIG. 3 or made available via a toolbar, tool pad and/or a pull down menu. Modifiers may be dragged and dropped to the desired location on a connection line. The management application may receive a user selection and designation of a modifier. The management application may indicate the inclusion of a modifier on a line by graphical modification of the line, such as by redrawing the line as grey or red or cross-hatching to indicate that a line has been modified. The management application may indicate the modification of a connection line by making the modification information visible as a property of the line as seen via a connection line menu window.

In one embodiment, the management application may allow for the sharing of connections. The management application may receive a user selection and designation of a shared connection. Certain abstract connections supporting multiplexed, shared media, or broadcast traffic, can support multiple connections over the same physical connection. In these situations, multiple use cases being the same or different, can be run at the same time. The management application may indicate in the property window of a connection line that a use case is shared and/or that the connection can be shared. In addition, this indication may be provided through a graphical cue such as a graphical image, by a use of a system designated color, and by other user interface techniques.

Alternatively, the system could derive that a connection is shareable based on the properties of a connection.

Closing Comments.

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For any means-plus-function limitations recited in the claims, the means are not intended to be limited to the means disclosed herein for performing the recited function, but are intended to cover in scope any means, known now or later developed, for performing the recited function.

As used herein, whether in the written description or the claims, “plurality” means two or more.

As used herein, whether in the written description or the claims, a “set” of items may include one or more of such items.

As used herein, whether in the written description or the claims, the terms “comprising”, “including”, “carrying”, “having”, “containing”, “involving”, and the like are to be understood to be open-ended, that is to mean including but not limited to. Only the transitional phrases “consisting of” and “consisting essentially of” are closed or semi-closed transitional phrases with respect to claims.

As used herein, “and/or” means that the listed items are alternatives, but the alternatives also include any combination of the listed items.

It is claimed:

1. A system for managing network devices comprising:
a server computer;
a client computer coupled with the server computer;
a connector device coupled with the server computer;
a plurality of network devices and/or physical layer devices coupled with the connector device;
a management application program stored on the server computer, the management application program providing a graphical user interface and configured to receive network device configuration information describing an arrangement of some of the plurality of network devices, receive a designation of a tap to be included in the arrangement between two of the network devices, wherein the tap is configured to obtain communications between the two network devices and provided the communication to a user.

2. The system of claim 1 wherein the graphical user interface of the management application is further configured to allow the user to select and arrange at least the network devices in a use case.

3. The system of claim 1 wherein the management application is further configured to provide a reservation system for the network devices.

4. The system of claim 1 wherein the graphical user interface of the management application is further configured to allow the user to designate a listening port.

5. The system of claim 1 wherein the graphical user interface of the management application is further configured to receive a user designation of a monitor, wherein the monitor is associated with the tap.

6. The system of claim 5 wherein the monitor provides access to information accessible via the tap.

7. The system of claim 1 wherein the management application is further configured to receive tests from the client computer, and run the tests on the network devices.

8. The system of claim 1 wherein the graphical user interface of the management application is further configured to receive a user designation of a modifier.

9. The method of claim 8 wherein the modifier is configured to perform a modification of a communications signal between two of the network devices.

10. The method of claim 9 wherein the modification of the communications signal is the addition of random noise to test performance under noisy conditions.

11. A method for managing network devices involving a server computer, a client computer coupled with the server computer, and a connector device coupled with the server computer, the method comprising:
coupling a plurality of network devices and/or physical layer devices with the connector device;
receiving via a management application program stored on the server computer network device configuration information describing an arrangement of some of the plurality of network devices;
receiving via the management application program a designation of a tap to be included in the arrangement between two of the network devices, wherein the tap is configured to obtain communications between the two network devices and provide the communications to a user.

12. The method of claim 11 further comprising:
storing via the management application the arrangement as a use case which may be later retrieved.

13. The method of claim 11 further comprising:
providing via the management application a reservation system for the network devices.

14. The method of claim 11 further comprising:
receiving via the management application a user designation of a listening port.

15. The method of claim 11 further comprising:
receiving via the management application a user designation of a monitor, wherein the monitor is associated with the tap.

16. The method of claim 15 wherein the monitor provides access to information accessible via the tap.

17. The method of claim 11 further comprising:
receiving via the management application program tests from a client computer; and
executing via the management application program the tests on the network devices.

18. The method of claim 11 further comprising:
receiving via the management application a user designation of a modifier.

19. The method of claim 18 wherein the modifier is configured to perform a modification of a communications signal between two of the network devices.

20. The method of claim 19 wherein the modification of the communications signal is the addition of random noise to test performance under noisy conditions.

21. A storage medium having instructions for managing network devices and/or physical layer devices stored thereon which when executed by a server computer having a connector device coupled therewith, the connector device having a plurality of network devices and/or physical layer devices coupled therewith, cause the server computer to perform actions comprising:
receiving configuration information describing an arrangement of some of the plurality of network devices;
receiving a designation of a tap to be included in the arrangement between two of the network devices, wherein communications between the two network devices are obtained by the tap and are provided to a user via a graphical user interface.

22. The storage medium of claim 21 having further instructions which when executed by the server computer cause the server computer to perform further actions comprising:
storing the arrangement as a use case which may be later retrieved by the user.

23. The storage medium of claim 21 having further instructions stored thereon which when executed by the server computer cause the server computer to perform further actions comprising:
providing a reservation system for the network devices.

24. The storage medium of claim 21 having further instructions stored thereon which when executed by the server computer cause the server computer to perform further actions comprising:
receiving a user designation of a listening port.

25. The storage medium of claim 21 having further instructions stored thereon which when executed by the server computer cause the server computer to perform further actions comprising:
receiving a user designation of a monitor, wherein the monitor is associated with the tap.

26. The storage medium of claim 25 wherein the monitor provides access to information accessible via the tap.

27. The storage medium of claim 21 having further instructions stored thereon which when executed by the server computer cause the server computer to perform further actions comprising:
receiving tests; and
executing the tests on the network devices.

28. The storage medium of claim 21 having further instructions stored thereon which when executed by the server computer cause the server computer to perform further actions comprising:
receiving via the management application a user designation of a modifier.

29. The storage medium of claim 28 wherein the modifier is configured to perform a modification of a communications signal between two of the network devices.

30. The storage medium of claim 29 wherein the modification of the communications signal is the addition of random noise to test performance under noisy conditions.
